(19) United States
(12) Patent Application Publication
(10) Pub. No.: US 2026/0257335 A1
(43) Pub. Date: Sep. 3, 2026

(54) POWER TOOL WITH DETACHABLE INPUT UNIT

(71) Applicant: Black & Decker Inc., New Britain, CT (US)

(72) Inventors: Tim Heimrich, Bad Camberg (DE); Daniel Kadlecek, Bischofsheim (DE); Jan Wussow, Waldsolms (DE); Alexander Davidson, Baltimore, MD (US)

(21) Appl. No.: 19/539,558

(22) Filed: Feb. 13, 2026

Related U.S. Application Data
(63) Continuation of application No. PCT/EP2024/071727, filed on Jul. 31, 2024.
(60) Provisional application No. 63/578,008, filed on Aug. 22, 2023.

(51) Int. Cl. B25F 5/02

(52) U.S. Cl. CPC B25F 5/02

(57) ABSTRACT

An input unit comprising a user operable switch for controlling a power connection from a power supply to a motor and a no-volt prevention circuit. A power tool comprising a main body, the main body comprising a motor and a controller; and an input unit arranged to be detachably connectable to the controller, the input unit comprising a user operable switch for controlling a power connection from a power supply to the controller; and a no-volt prevention circuit configured to prevent the motor from operating upon connecting the input unit to the controller when the user operable switch is in an ON configuration. A removable handle for a power tool comprising an input unit and a wire assembly for electrically connecting the input unit to the power tool.

### CROSS-REFERENCE TO RELATED APPLICATIONS

The present application is a continuation of International Patent Application No. PCT/EP2024/071727, filed on Jul. 31, 2024, entitled A POWER TOOL WITH DETACHABLE INPUT UNIT, which claims the benefit of priority of U.S. Provisional Patent Application No. 63/578,008, filed on Aug. 22, 2023, entitled A POWER TOOL WITH DETACHABLE INPUT UNIT.

### INCORPORATION BY REFERENCE

The disclosures of each of International Patent Application No. PCT/EP2024/071727, filed on Jul. 31, 2024, entitled A POWER TOOL WITH DETACHABLE INPUT UNIT, and U.S. Provisional Patent Application No. 63/578,008, filed on Aug. 22, 2023, entitled A POWER TOOL WITH DETACHABLE INPUT UNIT, are hereby incorporated by reference for all purposes as if set forth in their entireties.

### FIELD OF THE INVENTION

This invention relates to power tools with detachable input units comprising on/off controls and detachable power supplies.

The present disclosure relates to a power tool, and in particular to a control system and device for prevention of a dangerous restart in a power tool when an input unit is connected in an ON configuration.

### BACKGROUND

Some power tools include a motor, for example for driving a reciprocating or oscillating load. Such tools are often used to perform compacting tasks such as compacting soil, asphalt or hardcore, or hammering tasks such as breaking up concrete (e.g. a jack hammer). An example of a compacting power tool is a rammer which comprises a reciprocating foot which impacts and flattens the surface to be compacted. A rammer may also be known as a tamper, a soil compactor, a compactor, a jumping jack compactor, a jumping jack tamper, a plate compactor, or a vibratory plate. Rammers generally comprise an electric motor for driving the reciprocating plate or foot.

Many regulatory standards require power tools to be provided with a “no-volt release” feature. This feature prevents a power tool from operating when it is coupled to a power source when the tool's power switch is in an ON position. For example, if a battery pack is plugged into a battery receptacle of a power tool, or the power cord of a corded tool is plugged into an AC power output, while the tool trigger is pressed or its ON switch is activated, this feature prevents the tool from turning ON.

Some power tools are large, heavy, and are transported to work sites. To be transported efficiently it may be desirable to remove components of the power tools for transport for example, heavy batteries may be removed. In other examples, a handle which protrudes from the side of a tool, and which might significantly increase its size, can be removed.

It is desirable to develop a reliable no-volt prevention mechanism, preferably implemented in hardware for increased dependability, that prevents the power tool from beginning to operate when the tool is coupled to an input unit, for controlling power to the tool motor, while the tool's trigger switch or other user-actuatable input is actuated in order to avoid a tool restart dangerous to the user.

### SUMMARY OF THE INVENTION

According to one aspect there is provided a removable handle for attaching to a main body of a power tool, the removable handle comprising: an input unit; and a wire assembly for electrically connecting the input unit to the main body, the wire assembly comprising: a first wire coupled to the input unit; and an interface for coupling and decoupling the first wire to the main body. The handle is therefore able to be removed for storing and transporting the power tool.

In embodiments, the input unit comprises a no-volt prevention circuit configured to prevent a motor of the power tool from operating upon coupling the first wire to the main body when the input unit is in an ON configuration. In embodiments, the interface is configured for coupling and decoupling the first wire to a second wire coupled to the main body, and the no-volt prevention circuit is configured to prevent a motor of the power tool from operating upon coupling the first wire to the second wire when the input unit is in an ON configuration. The interface may comprise a plug and socket type connection. The plug and socket connect may comprise at least 6 pins. This allows for the removable handle to be connected to the power tool with the input unit in an ON configuration without causing the motor to start.

According to another aspect there is provided an input unit arranged to be detachably connectable to a controller of a power tool, the input unit comprising: a user operable switch for controlling a power connection from a power supply to the motor; and a no-volt prevention circuit configured to prevent a motor of the power tool from operating upon connecting the input unit to the controller when the user operable switch is in an ON configuration. The input unit is therefore able to be detached from the power tool and reconnected with the user operable switch in an ON configuration without causing the motor to start.

According to another aspect there is provided a power tool comprising: a main body, the main body comprising a motor and a controller; and a removable handle according to any one of claims 1 to 3, the removable handle being removably attachable to the main body. The power tool is therefore able to be stored and transported without the handle attached, but the handle can be reattached when the power tool needs to be used.

According to another aspect there is provided a power tool comprising: a power supply; a main body, the main body comprising a motor and a controller; a removable handle according to any one of claims 1 to 3, the removeable handle being removably attachable to the main body; the input unit having an OFF configuration in which a supply of power from the power supply to the motor is OFF and an ON configuration in which the supply of power from the power supply to the motor is ON, the input unit being user actuatable between the OFF configuration and the ON configuration; the wire assembly being for electrically connecting the input unit to the controller, and the interface being for coupling and decoupling the first wire to the controller; and the no-volt prevention circuit being configured to prevent the motor from operating upon coupling the first wire to the controller when the input unit is in the ON configuration. The power tool is therefore able to have the handle and input unit detached from the power tool and then reattached for use with the user operable switch in an ON configuration without causing the motor to start.

According to another aspect there is provided a power tool comprising: a main body, the main body comprising a motor and a controller; and an input unit arranged to be detachably connectable to the controller, the input unit comprising: a user operable switch for controlling a power connection from a power supply to the controller; and a no-volt prevention circuit configured to prevent the motor from operating upon connecting the input unit to the controller when the user operable switch is in an ON configuration. The power tool is therefore able to have the input unit detached from the power tool and then reattached for use with the user operable switch in an ON configuration without causing the motor to start.

In embodiments, the no-volt prevention circuit is configured to cause an ON signal to be sent to the controller on transition of the user operable switch from an OFF configuration to an ON configuration. Thus, causing the power tool to start based on a user action.

In embodiments, the no-volt prevention circuit is configured to cause an ON signal to be sent to the controller only when: an input is received from a power supply before the input unit is placed in an ON configuration. Therefore, the power tool is only started when the input unit is already connected to the power tool when the user turns it ON, and not when the input unit is connected in an already ON configuration such that both are done at the same time.

In embodiments, the no-volt prevention circuit is configured to cause a power signal to be output to a load switch in response to a transition of the user operable switch from an OFF configuration to an ON configuration. The no-volt provides a conditional check that the user operable switch has been actuated before allowing the load switch to receive power.

In embodiments, the no-volt prevention circuit is configured to cause the load switch to operate. In embodiments, the input unit comprises the load switch. In embodiments, the load switch is configured to couple the power supply to an output of the load switch in response to receiving a power signal from the no-volt prevention circuit. Therefore, the load switch in the input unit is activated based on the no-volt circuit output.

In embodiments, the input unit comprises a latch circuit configured to be connectable to the power supply. In embodiments, the latch circuit is configured to be connectable between an input of the load switch and an output of the load switch. In embodiments, the latch circuit is configured to output an OFF signal on connection of the input unit to the controller. A latch circuit is provided to ensure a stable ON signal is provided to the load switch. The latch circuit is able to output an OFF signal to prevent the load switch being powered.

In embodiments, a latch circuit output of the latch circuit is connected to the input of the load switch, and a latch circuit input of the latch circuit is connected to the output of the load switch, and the latch circuit is configured to: generate an ON signal at the latch circuit output in response to receiving an ON signal at the latch circuit input from the output of the load switch; and latch the latch circuit output to the ON signal until the received ON signal is interrupted. Thus, a stable ON signal is delivered to the load signal even if the ON signal received at the load switch from the no-volt circuit is stopped.

In embodiments, the latch circuit is configured to: output an ON signal to the load switch input in response to: receiving an ON signal from the load switch output; and receiving an ON signal from the user operable switch. The latch circuit is therefore configured to maintain the output of the ON signal so long as the user operable switch has provided an ON signal.

In embodiments, the input unit comprises a user-operable switch for placing the input unit into the ON configuration or an OFF configuration. In embodiments, the user-operable switch produces an output only when in an ON configuration. The user-operable switch may be locked in the ON configuration.

In embodiments, the removable handle is removably attached to the main body of the power tool by one or more removable attaching mechanisms. In embodiments, the one or more removable attaching mechanisms comprise a resilient element configured to pass through an arm of the handle and be secured behind a lip of an opening in the main body of the power tool. In embodiments, the one or more attaching mechanisms comprises one or more of: a pin, a screw and wingnut, a hook and lug, a clip, and a twistable lock nut. The handle can therefore be detached and reattached b the user efficiently and easily but is still secure.

In embodiments, the no-volt prevention circuit is configured to operate on an input voltage at or less than about 80 volts. In embodiments, the no-volt prevention circuit is configured to operate in a circuit with a power supply of 3.3V, 5V, 13V, 15V, 18V, 20V, 40V, or 60V. The no-volt prevention circuit is therefore configured to operate at voltages typically used to power and operate power tools.

In embodiments, the power supply is disconnectable from the motor and/or removably attachable to the main body. In embodiments, the power supply comprises a battery. This allows for the power supply to be removed for easy replacement once empty or reducing the weight of the power tool for transport.

In embodiments, the power supply and motor are located locally to the main body and on the opposite side of the interface to the input unit and no-volt prevention circuit. This ensures that the no-volt prevention circuit to be implemented on connection of the input unit is always present alongside the input unit.

In embodiments, the power tool comprises a further no-volt prevention circuit configured to prevent the motor of the power tool from operating upon connecting the power supply to the motor when the input unit is in an ON configuration. Therefore, the power tool is prevented from starting upon connection of the input unit to the power tool when already in an ON configuration and on connection of the power supply when the input unit is already in an ON configuration.

In an embodiment, the power tool is one of: a plate compactor; an early entry saw; a concrete trowel; a concrete roller; a walk-behind vibratory roller; a lawn mower.

### BRIEF DESCRIPTION OF THE FIGURES

The present invention will now be described by way of example with reference to the accompanying drawings. In the drawings:

FIG. 1 shows an example of a power tool.

FIG. 2 shows a close-up view of the interface for connecting the first wire to the main body of the power tool.

FIG. 3 shows a schematic example of the input unit circuit.

FIG. 4 shows a simplified example partial circuit diagram of a no-volt prevention circuit.

FIG. 5 shows a simplified example partial circuit diagram of a load switch.

FIG. 6 shows a simplified example partial circuit diagram of a latch circuit.

FIG. 7 shows an example arrangement of the interface, no-volt prevention circuit module, and user operable switch.

FIG. 8 shows an example arrangement of the interface, no-volt prevention circuit module, and user operable switch.

FIG. 9 shows an example of an input unit circuit.

### DETAILED DESCRIPTION OF THE INVENTION

The following description illustrates the claimed invention by way of example and not by way of limitation. The description clearly enables one skilled in the art to make and use the disclosure, describes several embodiments, adaptations, variations, alternatives, and uses of the disclosure, including what is presently believed to be the best mode of carrying out the claimed invention. Additionally, it is to be understood that the disclosure is not limited in its application to the details of construction and the arrangements of components set forth in the following description or illustrated in the drawings. The disclosure is capable of other embodiments and of being practiced or being carried out in various ways. Also, it is to be understood that the phraseology and terminology used herein is for the purpose of description and should not be regarded as limiting.

The present disclosure describes a plate compactor by way of example. Power tool 100 in the particular example provided may be a plate compactor, but it will be appreciated that the teachings of this disclosure are merely exemplary and the power tool of this invention could be any power tool. More generally, the powered device may be any kind of powered device, such as jack hammers, vibratory rammers, and lawn mowers.

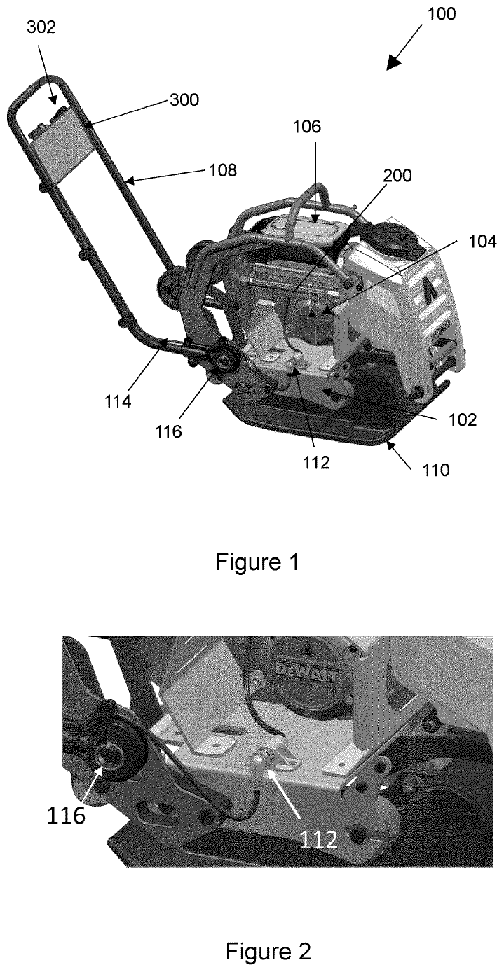

With reference to FIG. 1, a power tool 100 constructed in accordance with the teachings of the present disclosure is proposed. As an example of a power tool, FIG. 1 shows a plate compactor 100 illustrated in a side-on perspective view, the compactor 100 comprising a main body 102 and a vibrating plate portion 110. The compacting plate 110 is adapted for compacting soil, gravel, sand, silt or any other material to be compacted. The plate compactor also comprises a handle 108 by which a user can manoeuvre the compactor, a motor, and a battery pack or petrol tank 106 for powering the motor of the compactor.

The power tool shown in FIG. 1 may comprise an input unit 300, a motor 104, a power supply 106, a handle 108, and an electronic control module 200. According to an embodiment, motor 104 is received in motor housing of the main body 102. Motor 104 may be any type of motor and may be powered by an appropriate power source 106 (electricity, pneumatic power, hydraulic power, petrol).

According to an embodiment, power tool 100 further includes a user operable switch (hereinafter also referred to as a “trigger” or “power switch”) and a control module 200 (hereinafter also referred to as “electronic control module”, or “motor control module”). Motor control module 200, in an embodiment, may include a controller and electronic switching components for regulating the supply of power from the power supply 106 to motor 104. The control module 200 is disposed within the housing of the main body of the power tool 100. Though it should be understood that depending on the power tool shape and specifications, electronic control module 200 may be disposed at any location within or on the power tool.

Control module 200 may also integrally include components to support a user operated input unit 300 (hereinafter referred to as “input unit” 300) for receiving user function selections, such as an ON/OFF signal, variable-speed signal, and forward-reverse signal.

The control module 200 and motor 104 are located on the main body 102, whereas the input unit 300 may be located on the handle 108 of the power tool. Between the main body 200 and input unit 300 there is provided an interface 112 for coupling and decoupling the input unit to the main body. The interface 112 is accessible to a user and may be coupled or decoupled manually by the user.

There is provided an input unit 300 for providing control inputs to the power tool 100. The input unit comprises one or more input mechanisms for actuation by a user in order to control the operation parameters of the power tool. In an embodiment, input unit 300 may include a user operable ON/OFF power switch. However, other input mechanisms such as a variable-speed trigger, a touch-sensor, a capacitive-sensor, a speed dial, etc. may also be utilized. In an embodiment, an ON/OFF signal is generated upon initial actuation of the user operable switch 302. Based on the input signals from the input unit 300, the controller and electronic switching components of the control module 200 modulate and regulate the supply of power to motor 104.

A power source is provided to power the power tool 100. In the example in FIG. 1, the motor 104 is a petrol motor. In another embodiment, the motor 104 may be an electric motor and the power supply 106 may be a battery, for example a replaceable battery pack for a plate compactor. The power supply may be provided by another portable electrical power supply, and need not be incorporated into the power tool. The power supply may comprise a generator. In order to drive the motor, the control module comprises control logic configured to control a power switch circuit which provides voltage and current from the power supply 106 to the motor 104 under the control of the control logic. The power switch circuit is closed by a switch 302 on the input unit 300.

It is envisioned that the teachings of this disclosure may also be applied to a power tool with an AC power source. Such a power tool may include, for example, a rectifier circuit coupled to the AC power source. It should be understood that the teachings of this disclosure may be used in any other type of tool or product that includes a motor 104 and an input unit 300 having a selectively detachable interface therebetween, including, but not limited to, lawnmowers, string trimmers, vacuums, blowers, sweepers, edgers, etc.

A detailed description of the mechanical aspects of the electronic control module 200 is beyond the scope of this disclosure. Examples of such a module may be found in co-pending patent application Ser. No. 15/603,837 filed May 24, 2017, the content of which is incorporated herein by reference in its entirety.

The present disclosure describes apparatus for controlling the start of a motor of a power tool. The apparatus described comprises a removable handle comprising a user operable switch for starting the motor. The handle may be removed to reduce the size of the power tool. This can be particularly useful for reducing one or more dimensions of the tool for storage or transportation purposes. Further, there is described an input unit which may be coupled or decoupled via an interface to the main body of the power tool. The input unit may include a no-volt prevention circuit to prevent unintentional activation of the power tool upon connection of the input unit to the main body of the power tool when a user operable switch is already in an ON configuration. Thus, the no-volt circuit within the input unit acts as a safety mechanism. The input unit may be located on a handle of the power tool which may also be detachable from the main body.

Specifically, there is provided a removable handle for attaching to a main body of a power tool. The removable handle comprises an input unit mounted to the handle. The removable handle also comprises a wire assembly for electrically connecting the input unit to the main body. The wire assembly comprises a first wire coupled to the input unit and an interface for coupling and decoupling the first wire to the main body.

The first wire 114 is shown in FIG. 1, running along the left side of the handle 108 from the input unit 300 to the main body 102 of the power tool. The first wire may be a cable comprised of multiple individual wires for connecting to multiple parts of the input unit circuitry. The first wire may be of any length sufficient to span a distance between the main body of the power tool to the input unit for inputting controls to the power tool.

FIG. 2 shows a close-up view of the interface 112 for connecting the first wire 114 to the main body 102 of the power tool 100. The interface 112 is shown in FIG. 2 as located on the main body 102 of the power tool 100. The interface may comprise any suitable wire connector housing having one or more individual connection points within it. The interface may comprise plug and socket type connection. The pins of one side of the interface may be configured to engage groves in the opposite side of the interface. The interface may be a standard cable harness for connecting multiple wires. For example, the interface may comprise a 10-pin connector. It should be understood that the interface may be located at any point along the wired connection from the main body 102 of the power tool to the input unit 300. As such there may be a second wire arranged to connect the main body 102 of the power tool to a second side of the interface 112, where the first side of the interface is configured to be connected to the first wire 114. The second wire may exist internally to the main body housing 102, or be external to the housing. The second wire, in combination with the first wire and the interface, allows for the input unit 300 to be connected to the controller 200 and in turn to the motor 104 such that input control signals entered at the input unit can be executed.

The interface may be provided with a plurality of pins for making electrical connections to wires attached to these pins. The interface may comprise a standard connector. The connector may comprise any suitable number of pins. For example, the interface connector may comprise at least 6 pins. For example, the 6-pin header of the plug and socket interface may be a S06-PASK-2 type connector. In other examples, the interface may comprise 8 pins or 10 pins. The interface may comprise a 2-pin header and a 6-pin header. It should be understood that it is possible to change the footprint of the connector style. The interface arrangement may also be flexible so that other connector styles may be used. As discussed below, a 2-pin header may be used for more flexibility when implementing the user switch 302. An example 2-pin header may be a S02-PASK-2 type connector.

Suitably, the pin connections enable a switch signal pin to be spaced from a Vout pin. For example, a pin separating the switch signal pin and the Vout pin may be left unconnected. This arrangement helps ensure that there is no short between the switch signal pin and the Vout pin.

The interface may comprise a robust and/or waterproof connector. The interface may be robust by inclusion of a mechanical securing mechanism. For example, the handle side of the connector may be screwed into the opposite connector on or attached to the main body of the power tool. The securing mechanism may be part of a connector housing which covers the plug and socket type interface. The connector housing may be configured to secure the plug and socket interface against vibrations which may cause the interface to separate. That is, the pins of the interface may be held into their corresponding holes by a securing mechanism. This may prevent the rough environment and vibrations of the power tool causing undesired separation at the interface. The securing mechanism may also provide a waterproof seal. For example, the connector housing may comprise two mating halves attached to and surrounding each of the opposing sides of the interface. Thus, when connected they suitably create a watertight housing around the interface. For example, an IP6x rated junction (for example IP62, 63, 64, 65, 66, 67, or 68) or an IPX6 or IPX7 rated type protective junction may be incorporated into the interface. The water resistance may be implemented such that the main power tool can be cleaned with a water pressure washer, operated in the rain, or left outside in various weather conditions without allowing water to interfere with the electrical connection at the interface.

Accordingly, a power tool is described comprising a main body, a motor control module, and a motor, and an interface arranged to connect to an input unit. The input unit is provided with a user operable switch actuatable by a user and configured to turn the supply of electric power from the power supply to the motor control module and thus the motor ON or OFF. The input unit is coupled to the power supply. A no-volt prevention circuit is also provided. The no-volt prevention circuit enables supply of power from the power supply when the user operable switch is actuated after the input unit is coupled to the power supply, but not when the user operable switch is actuated before the input unit is coupled to the power supply.

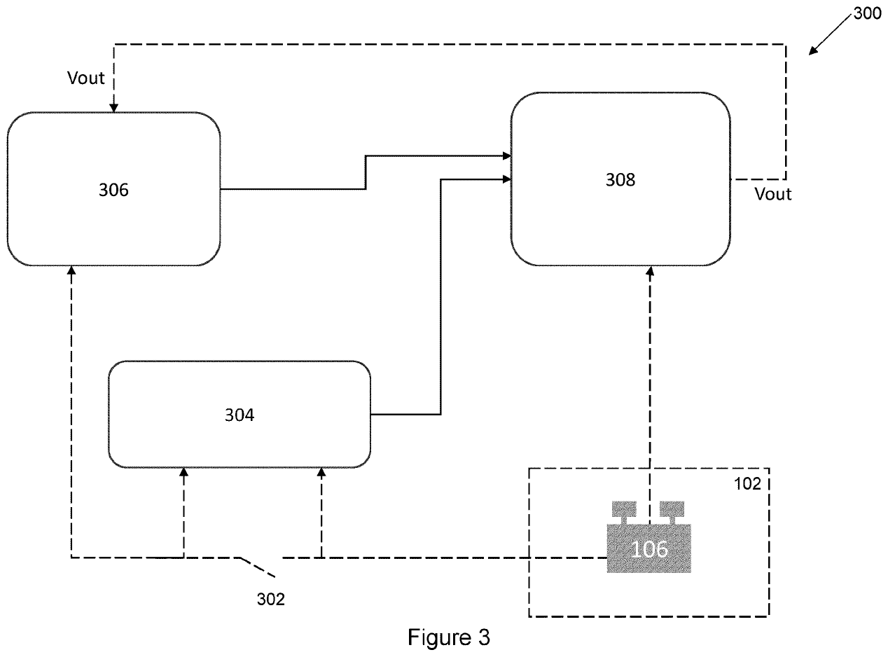

FIG. 3 shows an example of the input unit 300 and its circuitry according to one embodiment. The input unit circuitry is shown as a schematic representation and comprises a plurality of modules. It should be understood that in some embodiments there may be additional circuit modules included in the input unit or alternatively only a selection of those shown in FIG. 3. For example, in an embodiment the no-volt module may be included in the input unit, but the latch circuit and the load switch may be located within the circuitry of the main body of the power tool.

FIG. 3 shows a no-volt module 304, a latch circuit module 306, and a load switch module 308. Together these modules provide one example of a circuit which can be implemented to provide a safety mechanism for preventing the unintentional starting of a motor of a power tool. The circuit additionally comprises a user operable switch 302 for manually turning the power tool ON. For example, the safety mechanism may be used in the case where the input unit 300 is connected to the power tool, including the motor and power supply, with the user operable switch already in an ON configuration. In the described scenario it is not desirable for the power tool to be switched ON. Specifically, the no-volt circuit module 304 can be utilized to prevent the described scenario from happening.

Each module in FIG. 3 provides a particular function. For example, consider the case where the input unit 300 of the power tool is already attached as depicted in FIG. 3, with the power supply 106 shown in the bottom right-hand corner. In this case the input unit 300 is connected, but the user operable switch 302 is in an OFF configuration. As a result, there is no power flowing in the circuit. The user may then actuate the user operable switch 302 such that it is transitioned from an OFF configuration to an ON configuration. This situation represents the typical expected operation of the power tool. In this case, the switch 302 closes the circuit.

The no-volt circuit module 304 is connected to the power source prior to closing the switch 302. Upon closing switch 302 the no-volt module 304 is configured to allow a voltage to be output to a load switch module 308. Load switch module 308, in response to receiving a voltage output from the no-volt circuit module 304, allows the input voltage (e.g. received from a battery 106), to pass to a load switch module 308 output, Vout. Vout can be used to drive the motor of the power tool. The load switch module 308, already connected to the power supply 106, is configured to output a voltage to a latch circuit module 306 in response to receiving a voltage from the no-volt circuit module 304. The latch circuit module 306 is directly connected to the power supply 106 and so, with the user operable switch 302 already having been placed in an ON configuration, the latch circuit module 306 is configured to allow the received voltage from the load switch module 308 to flow through the latch circuit module 306 and be output directly to a load switch module 308 input. This arrangement bypasses the no-volt circuit module 304. This arrangement permits Vout to be maintained once the no-volt circuit module 304 initially passes a voltage.

Due to the circuits within the modules and their components, the flow of the voltage supply can be engineered to take more time through some routes than others. By exploiting this effect, i.e. a non-instantaneous signal propagation through circuits or circuit portions, it is possible to ensure that certain outcomes only occur when preceded by other specific events. For example, providing power to the motor only when the user operable switch on the input unit is transitioned to an ON configuration after the input unit is already connected to the main body 102 and therefore the power supply 106.

Now consider the case where the input unit 300 of the power tool is not attached to the main body and the power supply, but the user operable switch is in an ON configuration. Since the input unit 300 is not connected, there is no power flowing in the circuit. The user may then attach the input unit 300 to the main body of the power tool, with the user operable switch already in an ON configuration. In this case, the switch 302 closes the circuit at the same time the power supply is provided to the circuit. The no-volt circuit module 304 is connected to the power source at the same time as ‘closing’ the switch 302 as both actions are provided by connecting the input unit at the interface. The no-volt module 304 is configured to only allow a voltage to be output to the load switch module 308 when the power supply is connected before the user switch 302 is placed in an ON configuration. As a result, in this situation, the no-volt circuit module 304 therefore does not output a voltage to the load switch module 308 that would cause the load switch module to pass a motor driving voltage to Vout, and the motor of the power tool therefore does not start.

The user may then actuate the user operable switch 302 to transition the switch from an ON configuration to an OFF configuration. At this point the system is restored to the typical expected operation state described above, where the input unit is connected to the main body when in an OFF configuration. The user may then actuate the user operable switch 302 to turn the power tool ON.

In this embodiment, the switch signal is coupled to the output of the user operable switch 302, i.e., along the current path from the power supply to the latch circuit module 306. Accordingly, the voltage of the switch signal may be equivalent to the battery voltage when the battery pack is received in the tool 100 and the user operable switch 302 is closed. The switch signal is thus an active-high signal, meaning that it produces a high voltage when the power tool 100 is turned ON. It should be understood that the circuit, as exemplified in the schematic circuit diagrams provided herein, may be configured such that the voltage on the active-high switch signal is less than the power supply voltage.

Therefore, there is provided, an input unit 300 arranged to be detachably connectable to a controller of a power tool 100. The input unit comprising a user operable switch 302 for providing power from a power supply 106 to the motor 104. The input unit also comprises a no-volt prevention circuit 304 configured to prevent a motor of the power tool from operating upon connecting the input unit 300 to the controller when the user operable switch 302 is in an ON configuration. As described above, the no-volt prevention circuit 304 is configured to prevent unintentional start-up of the power tool.

The input unit may also be included in a removable handle for a power tool. Thus, there is also provided a removable handle for attaching to a main body of a power tool. The removable handle comprises an input unit as described herein. The removable handle also comprises a wire assembly for electrically connecting the input unit to the main body. The wire assembly comprises a first wire coupled to the input unit and an interface for coupling and decoupling the first wire to the main body.

The removable handle may form part of a power tool. Therefore, there is also provided a power tool comprising a main body and a removable handle. The main body comprises a motor and a controller. The removable handle comprises at least an input unit as described herein. The removable handle is removably attachable to the main body.

The power tool may be any one of a plate compactor, an early entry saw, a concrete trowel, a concrete roller, a walk-behind vibratory roller, or a lawn mower. In an embodiment the power tool may be a strimmer, a hedge trimmer, a sander, a grinder, a drill, a saw, or a nail gun.

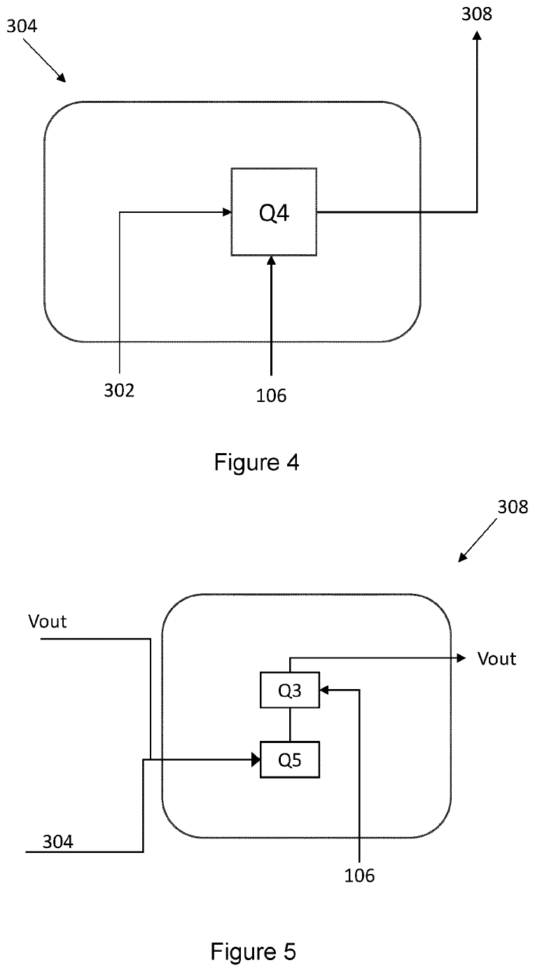

Referring now to FIG. 4, an embodiment of the no-volt circuit for prevention of dangerous restart is described. The no-volt circuit is specifically implemented to prevent a dangerous restart condition from taking place when the input unit 300 is plugged into, or connected to, the power tool 100 where the user operable switch 302 is in an ON configuration.

FIG. 4 depicts a simplified partial circuit diagram of a no-volt prevention circuit 304, according to this embodiment. The no-volt prevention circuit is configured to receive a signal from the power supply 106 and a signal from the user operable switch 302.

In an embodiment, circuit 304 includes a switch Q4 disposed between the power supply (e.g. from the battery) and the power input controlled by the user operable switch 302. The switch Q4 may comprise a transistor switch. The source of the switch Q4 is coupled to the output of the user operable switch 302. There may be a number of further circuit components disposed between the switch 302 output and the switch Q4 source. These components may comprise one or more resistors and capacitors to provide a resistor-capacitor (RC) circuit having a time constant. This RC circuit may be used to control or delay the progress of a voltage signal through the circuit depending on the specific choices of resistance and capacitance values, which affect the time constant of the circuit.

The gate of the switch Q4 is coupled to the power supply 106 (e.g. a battery). Just as for the source coupling of switch Q4, there may be a number of further circuit components disposed between the power supply 106 and the switch Q4 gate. These components may comprise one or more resistors and capacitors to provide an RC circuit. This circuit may be used to control or delay the progress of a voltage signal through the circuit depending on the specific choices of resistance and capacitance values, which determines the circuit time constant. The no-volt prevention circuit may comprise a first RC circuit associated with the signal received from the power supply, and a second RC circuit associated with the signal received via the input unit.

The drain of the switch Q4 is coupled to an input of the load switch module 308. The switch Q4 is configured such that it is switched ON, i.e. a current flows from source to drain, only if a threshold potential difference is reached e.g. between gate and source. Therefore, when the gate of Q4 is connected to the power supply, e.g. a battery, before the switch 302 is actuated and placed in an ON configuration to provide power to the source, Q4 is switched ON and a current is allowed to flow to the drain and thus to the load switch 308. Alternatively, if the power supply 106 (e.g. the battery) coupled to the gate, and the switch 302 coupled to the source (e.g. connecting the battery voltage to the source), are connected simultaneously to the no-volt module 304, the potential difference threshold is not reached between the gate and the source (due to the RC circuits), and Q4 does not turn ON. This will be the case where the input unit 300 is connected by the user with the user operable switch 302 already in the ON configuration. RC circuits may be calibrated such that when both the power supply and switch are engaged with module 304 simultaneously the switch Q4 of the no-volt circuit module 304 will not turn ON.

In this way it is possible to control the onward electrical power to the load switch 308. Fulfilling certain criteria at the no-volt circuit 304 can thus be used to control the load switch operation. Where the no-volt circuit passes a voltage signal, the load switch can be caused to switch ON. Where the no-volt circuit does not pass a voltage signal, the load switch can be caused to remain OFF.

In an embodiment, one or both RC circuits may comprise a ground node. Further, there may be a diode placed between the drain of switch Q4 and the load switch module 308 to ensure the power only flows to the load switch module 306.

Thus, there is provided herein an input unit comprising a no-volt prevention circuit configured to prevent a motor of the power tool from operating upon coupling the first wire to the main body when the input unit is in an ON configuration. The interface may be configured for coupling and decoupling the first wire to a second wire coupled to the main body, and the no-volt prevention circuit may be configured to prevent a motor of the power tool from operating upon coupling the first wire to the second wire when the input unit is in an ON configuration.

The no-volt prevention circuit may be configured to cause an ON signal to be sent to the controller (e.g. via a load switch as described herein), on transition of the user operable switch from an OFF configuration to an ON configuration.

The no-volt prevention circuit may therefore be configured to provide an output only when the input from the power supply is received before the input unit is placed in an ON configuration. The no-volt prevention circuit may also be configured to cause an ON signal to be sent to the controller only when an input is received from a power supply before the input unit is placed in an ON configuration.

The no-volt prevention circuit may thus be configured to cause a power signal to be output to a load switch in response to a transition of the user operable switch from an OFF configuration to an ON configuration. The no-volt prevention circuit may be configured to cause a load switch to operate.

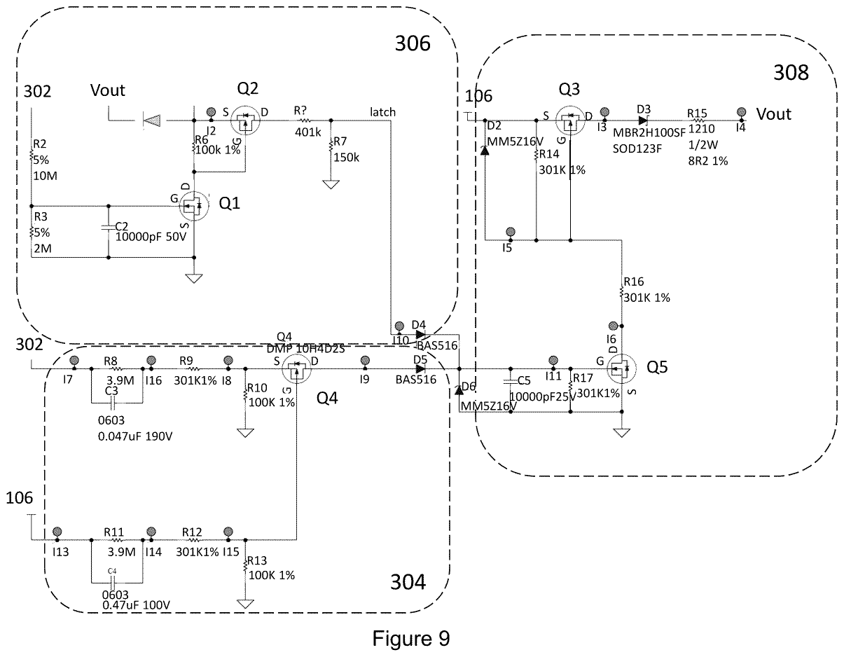

The no-volt prevention circuit may be configured to operate on an input within a range of at or less than about 80 volts. More specifically, the no-volt prevention circuit may be configured to operate in a circuit with a power supply of 3.3V, 5V, 13V, 15V, 18V, 20V, 40V, or 60V. For example, the no-volt prevention circuit may be adjusted to any voltage level of batteries at 20V, 40V, or 60V. It is also possible to use the voltage supply from a main electronic supply, for example 13V, 5V, or 3.3V. Therefore, there is provided full flexibility for DC voltages of about 60V and below. For more than 60V DC, for example about 80V and below, additional components and circuitry may be required due to safety and design regulations. The example circuitry of FIG. 9 is arranged for a 60V power supply. Therefore, the values shown in FIG. 9 for specific components may be changed depending on the voltage of the power supply. It should be understood that the voltage at which the circuit operates may depend on the running voltage of the motor as well as the running voltage of other components in the power tool. Similarly, the running voltage may depend on the power supply configured to power the power tool, e.g. AC power supply or battery pack etc.

FIG. 5 depicts a simplified partial circuit diagram of a load switch module 308, according to one embodiment. The load switch module may receive an input from the no-volt prevention circuit 304. The load switch module may also be directly connected to the power supply 106. The load switch module may be configured to couple the power supply to an output of the load switch in response to receiving a power signal from the no-volt prevention circuit. The load switch module may also receive an input from a latch circuit module 306. The load switch module may thus be configured to couple a power supply to an output of the load switch in response to receiving a signal from the latch circuit module. The signal from the latch circuit module can be dependent on receiving at the latch circuit module a power signal from the load switch module. That is, the latch circuit can latch a power signal output from the load switch.

The load switch module is configured to operate as a conditional switch. If the circuit of the load switch module receives a power signal from the no-volt circuit module, the load switch circuit is configured to connect the input power supply to the load switch module output. In an embodiment the load switch circuit is connected to a latch circuit module such that the power signal is output to the latch module. The load switch circuit may also be configured to receive a power signal from the latch module, the load switch circuit then being configured to connect the input power supply to the output if it receives a power signal from the latch circuit module.

In an embodiment, the load switch circuit comprises two switches: Q5 and Q3. One or both of the switches can comprise a transistor. The switch Q3 is turned ON by receiving an input power signal from the no-volt circuit of a sufficient voltage. The switch Q3 may also be configured to switch ON in response to receiving a power signal from the latch circuit of sufficient voltage. The sufficient voltage may be a threshold voltage selected based on the voltage of the input unit circuit power supply and specific component values.

The switch Q3 is configured to turn ON switch Q5. When switched ON, switch Q5 is configured to connect the input power supply to the load switch module output. Suitably, the switch Q5 is configured to switch ON in response to receiving a power signal from switch Q3 of sufficient voltage. The sufficient voltage may be a threshold voltage selected based on the voltage of the input unit circuit power supply and specific component values. The threshold voltage for switches Q3 and Q5 need not be the same, but they might be the same.

The input unit may therefore comprise a load switch as described above. The input unit may comprise a load switch configured to couple a power supply to an output of the load switch in response to receiving a power signal from a no-volt prevention circuit. The load switch may comprise at least one conditional switch. The conditional switch may be a transistor. Switches described herein may comprise semiconductor switches such as Field-Effect Transistors (FETs), and/or any other type of solid-state switch, such as Insulated-Gate Bipolar Transistors (IGBT), Bipolar Junction Transistors (BJT), etc. References made in this disclosure to a “gate,” “source,” or “drain” of such semiconductor switches should accordingly be understood to cover corresponding nodes (e.g., base, collector, emitter, etc.) of the semiconductor switch being utilized.

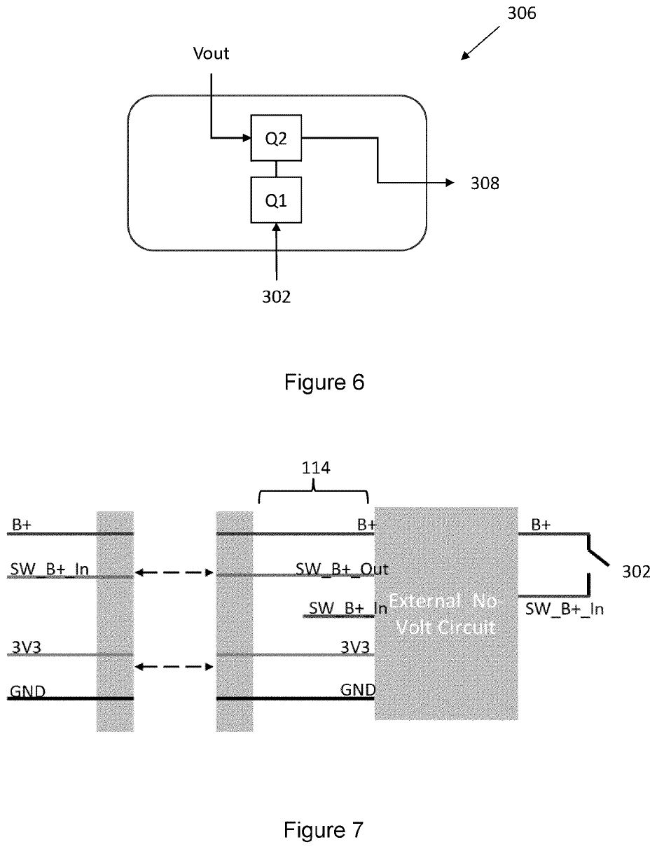

FIG. 6 depicts a simplified partial circuit diagram of a latch circuit module 306, according to one embodiment. Latch circuit module 306 may be configured to receive, as an input, an output of the load switch module 308. The latch circuit module is also configured to receive a power signal when the user operable switch 302 is in an ON configuration. The latch circuit module 306 is configured such that in response to receiving said power signal, the latch circuit module causes a power signal received from the load switch module to be connected (or to remain connected) to an output of the latch circuit module, and thereby to an input of the load switch module. As a result of this connection the latch circuit latches the load switch in an ON state.

In reference to FIG. 6, in response to receiving a power signal when the user operable switch 302 is in an ON configuration, a conditional switch Q1 (which may comprise a transistor) is turned ON. In response to switch Q1 turning ON a further conditional switch Q2 (which may be a transistor) is turned ON. When switch Q2 is turned ON the received power signal from the load switch module 308 is connected to an output of the latch circuit module, and thereby to an input of the load switch module 308. Thus, the power signal is latched so that it flows continuously through the power tool motor control module 200 and motor 104 to provide power from power supply 106. This may be configured to continue until the ON signal enabled by switch 302 being in an ON configuration stops by transitioning user operable switch 302 to an OFF configuration.

Therefore, in an embodiment, the input unit comprises a latch circuit configured to be connectable to the power supply of a power tool. The latch circuit may be configured to be connectable between a load switch output and a load switch input. The latch circuit may be configured to output an OFF signal on connection of the input unit to the controller. That is, when the input unit is connected to the power tool with the user operable switch already in an ON configuration there is no output provided by the no-volt prevention module, which results in no signal being output by the load switch module, and consequently an OFF signal may be output by the latch circuit module. The OFF signal may be an absence of an ON signal.

That is, a latch circuit output of the latch circuit may be connected to the input of the load switch, and a latch circuit input of the latch circuit is connected to the output of the load switch. In an embodiment, the latch circuit may then be configured to generate an ON signal at the latch circuit output in response to receiving an ON signal at the latch circuit input from the output of the load switch and latch the latch circuit output to the ON signal. The ON signal may continue to be output by the latch circuit until the received ON signal is interrupted. For example, actuating the user operable switch such that it transitions to an OFF configuration may cause the interruption. Alternatively, a specific switch configured to cause an interruption of the received ON signal may be implemented.

The latch circuit may be configured to output an ON signal to a load switch input in response to receiving an ON signal from a load switch output; and receiving an ON signal from the user operable switch. That is, both of an ON signal from the load switch module and an ON signal from the user operable switch 302 may need to be received in order for the latch circuit to continue to output an ON signal to the load switch.

Where the user operable switch 302 transitions from an ON configuration to an OFF configuration, the signal received at switch Q1 will go from (e.g.) HIGH to LOW. This change in signal will cause switch Q1 to turn OFF, thereby also turning OFF switch Q2. Hence, where a user moves the user operable switch to the OFF configuration, the latch circuit ceases outputting the ON signal. Where the user operable switch is moved to the OFF configuration, the no-volt prevention circuit will also be caused to output an OFF signal (or LOW). The load switch will thereby be caused to cease outputting the power signal, and the power tool will turn off.

It will be understood that the time taken for the power tool to turn off depends on the values chosen for circuit components. Suitably the time taken for the power tool to turn off after the user operable switch is moved to the OFF configuration is less than 500 ms, more preferably less than about 100 ms, and most preferably less than about 50 ms.

In an embodiment the latch circuit may be configured to be operable in a timeframe less than the duration of a steady state of the no-volt circuit initiated by the transition of the user operable switch from an OFF configuration to an ON configuration. That is, the ON signal may be latched by the latch circuit within a timeframe that is shorter than the time it would take the no-volt circuit to reach a steady state. The steady state is due to the charging of capacitors in the RC circuits of the no-volt prevention circuit which is started in response to receiving an ON signal. This would ensure that the power tool is turned on before the ON signal from the no-volt prevention circuit ends.

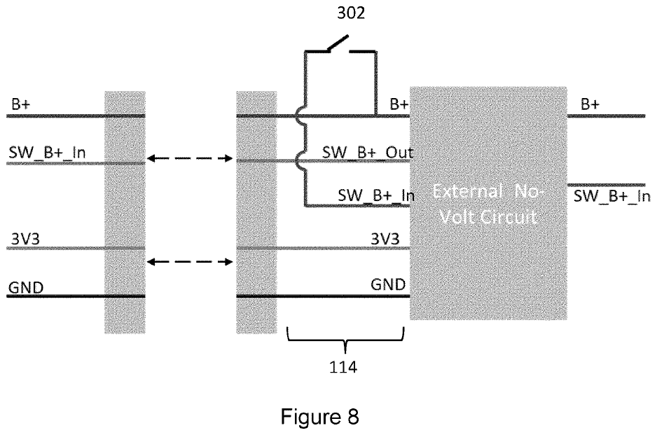

FIGS. 7 and 8 illustrate two examples of a section of the input unit 300 circuitry. Specifically, the two examples illustrate two different configurations for arranging the interface, no-volt prevention circuit module, and user operable switch 302.

In FIG. 7 the user operable switch 302 is connected on the opposite side of the input unit circuit to the interface. This configuration is advantageous when using a cable harness for the interface and the user operable switch 302 is a micro-switch.

In FIG. 8 the user operable switch 302 is connected on the same side of the input unit circuit as the interface. This configuration is advantageous as it allows for all connections to be made on the main switch header.

The configuration of FIG. 7 may be preferred over that of FIG. 8 due to the requirement in the FIG. 8 configuration of splicing the positive power supply input from the power source 106 between the interface and the input unit circuitry.

FIGS. 7 and 8 show the above-defined first wire 114 between the interface and the input unit circuitry. The first wire 114 may be a single wire or part of a cable comprising multiple individual wires for connecting to multiple parts of the input unit circuitry. For example, there may be a single wire for carrying an input power voltage to the input unit. There may be a single wire for carrying an output power voltage from the input unit. There may be a single wire for connecting the input unit to ground. There may be a single wire from the input unit circuitry for connecting via the user operable switch 302 to the input power wire.

The Input unit described herein thus may comprise a user operable switch 302 for placing the input unit into an ON configuration or an OFF configuration. The user operable switch 302 may produce an output only when in an ON configuration.

The power tool may comprise a removeable handle. Thus, as described herein, there is provided a power tool comprising a power supply and a main body. The main body comprising a motor and a controller, and a removable handle which is removably attachable to the main body. The input unit having an OFF configuration in which a supply of power from the power supply to the motor is OFF and an ON configuration in which the supply of power from the power supply to the motor is ON. The input unit is user actuatable between the OFF configuration and the ON configuration. The wire assembly described herein is provided for electrically connecting the input unit to the controller. The interface described herein is provided for coupling and decoupling the first wire to the controller. The no-volt prevention circuit described herein is configured to prevent the motor from operating upon coupling the first wire to the controller when the input unit is in the ON configuration.

In another configuration comprising a removeable handle, there is provided a power tool comprising a main body. The main body comprises a motor and a controller. The power tool also comprises an input unit arranged to be detachably connectable to the controller. The input unit comprises a user operable switch for controlling a power connection from a power supply to the controller, and a no-volt prevention circuit configured to prevent the motor from operating upon connecting the input unit to the controller when the user operable switch is in an ON configuration. The user-operable switch may be locked in the ON configuration.

The power tool may be configured such that the removable handle is removably attached to the main body of the power tool by one or more removable attaching mechanisms. The one or more removable attaching mechanisms may comprise a resilient element configured to pass through an arm of the handle and be secured behind a lip of an opening in the main body of the power tool. The one or more attaching mechanisms may comprise one or more of a pin, a screw and wingnut, a hook and lug, a clip, and a twistable lock nut. An example of a pin attaching mechanism is shown in FIG. 2, at reference number 116.

It should be understood that the input unit described herein may be configured to be removably attachable to the removable handle of the power tool. Similarly, the power supply 106 may be disconnectable from the motor, removably attachable to the main body, or both. For example, the power supply may comprise a battery. The power supply and motor may be located locally to the main body and on the opposite side of the interface to the input unit and no-volt prevention circuit. That is, the power supply may be housed on the main body of the power tool which also comprises the motor, and the no-volt prevention circuit located within the input unit which may be located on the handle, with the main body and the input unit connected via the interface.

In an embodiment, the power tool may comprise a further no-volt prevention circuit configured to prevent the motor of the power tool from operating upon connecting the power supply to the motor when the input unit is in an ON configuration. That is, there may be another no-volt prevention circuit provided on the main body of the power tool in addition to the no-volt circuit in the input unit.

FIG. 9 shows an example of an input unit circuit. The areas of the example circuit which comprise the no-volt prevention circuit module 304, the load switch circuit module 308, and the latch circuit module 306 are indicated by a dashed line encircling the relevant components. These parts of the example circuit are described in more detail below.

The no-volt prevention circuit 304 relies on two RC circuits to turn ON the main switch Q4 only when the user operable switch 302 is activated while power 106 is being supplied. E.g., the switch 302 is placed in an ON configuration after the input unit is plugged into the power tool. Also referred to herein as the “normal condition”. An “abnormal condition”, in which it is desirable for the motor to remain OFF, arises when battery power is connected with the user operable switch 302 already in an ON configuration. (e.g., by connecting the input unit at the interface to the power tool 100 when the user operable switch is already in an ON configuration).

In the illustrated example, the no-volt prevention circuit 304 includes a capacitor C4 and resistors R11 and R12 forming an RC circuit between the power supply 106 and the gate of the main switch Q4. A further resistor R13 also couples the gate of the main switch Q4 to a ground node. The ON signal from the user operable switch 302 is coupled to the source of main switch Q4 via a further RC circuit. This RC circuit includes a capacitor C3 and resistors R8 and R9 forming an RC circuit between the ON signal from the user operable switch 302 and the source of the main switch Q4. A further resistor R10 couples the source of the main switch Q4 to a further ground node.

The two RC circuits can be designed to have the same resistance and capacitance values. Thus the charge time of the capacitors is the same when the power supply is initiated at the same time as the ON signal via the user operable switch is provided. This prevents the potential difference threshold being reached to switch Q4 ON, and so an ON signal is not passed to the load switch module.

When the ON signal is activated by operation of the user operable switch after the input unit is connected and power is already being supplied, the power fully charges the capacitor C4 through resistor R11 prior to the ON signal being sent from the user operable switch. In an illustrative example, where the power supply has a 20V voltage, the first capacitor C4 voltage is charged to 20V (or almost 20V, in steady state). The gate of the main switch Q4, which is coupled to the capacitor C4 via resistor R11 and R12, will be at the same potential. In an embodiment, main switch Q4 is a solid state switch, and therefore remains OFF as long as its source to gate potential difference remains below a gate threshold (e.g., 4V). Therefore, so long as the potential at source and gate remains equal, the gate will not come ON. When the gate has a high voltage compared to the source (e.g. gate voltage exceeds source voltage by at least 4V), Q4 is switched ON.

In an embodiment, load switch module 308 includes a main switch Q3 disposed between the power supply and the load switch output. The source of the main switch Q3 is coupled to its gate via a resistor R14 and a Zener diode. The gate of the main switch Q3 is further controllable via a control switch Q5 disposed between a ground node and the gate of the main switch Q3 through a resistor R16. The gate of the control switch Q5 is controlled via a signal from the no-volt prevention circuit in a manner to prevent a no-volt condition, as described herein, and an ON signal from the latch circuit module.

A capacitor C5 is disposed between the two input signals and the gate of switch Q5. A Zener diode D6 is disposed between the capacitor C5 and the source of the control switch Q5. Resistor R17 couples the source of Q5 to the ground. During normal condition, i.e., when the ON signal is activated (e.g. by the user actuating the user operable switch 302) after the input unit is already connected and power is being supplied, the power charges the C5 capacitor. For example, if the battery nominal voltage is 20V the capacitor C5 is charged to 20V (or almost 20V, in steady state). With this arrangement, the voltage becomes large enough to turn ON the control switch Q5. The control switch Q5 subsequently grounds the gate of the main switch Q3, thus causing Q3 to turn ON, connecting the power supply to the voltage output of the load switch module.

FIG. 9 also illustrates an example latch circuit 306. When the user operable switch is in the ON configuration, the capacitor C2 begins charging, with the power supply voltage (via the user operable switch) flowing into the capacitor C2 through the resistor R2 and resistor R3. The current rapidly spikes and gradually decreases as the capacitor C2 is charged. It is noted that C2 has a relatively small capacitance and therefore gets charged comparatively quickly. This current flowing through resistor R2 causes the source to gate voltage difference of the main switch Q1 to exceed the main switch gate threshold. This turns ON the main switch Q1. This causes the gate of switch Q2 to be grounded. Then, when a voltage exceeding the gate-source threshold voltage of switch Q2 is received at the source of switch Q2, switch Q2 will turn ON.

As described elsewhere herein, switch Q2 is turned ON by the load switch module 308 outputting a battery voltage (e.g. 20V, 40V, or 60V). With switch Q2 ON, the latch circuit output causes the load switch module to continue outputting the battery voltage, thereby latching the power ON. Power is turned OFF by moving the user operable switch to the OFF configuration, which causes switch Q1 to turn OFF, thereby switching switch Q2 OFF.

In an embodiment, the latch switch Q1 is an n-type semiconductor switch which grounds the gate of switch Q2 when switch Q1 is ON.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A removable handle for attaching to a main body of a power tool, the removable handle comprising:
an input unit; and
a wire assembly for electrically connecting the input unit to the main body, the wire assembly comprising:
a first wire coupled to the input unit; and
an interface for coupling and decoupling the first wire to the main body.

2. The removable handle according to claim 1, wherein the input unit comprises a no-volt prevention circuit configured to prevent a motor of the power tool from operating upon coupling the first wire to the main body when the input unit is in an ON configuration.

3. The removable handle according to claim 1, wherein the interface is configured for coupling and decoupling the first wire to a second wire coupled to the main body, and the no-volt prevention circuit is configured to prevent a motor of the power tool from operating upon coupling the first wire to the second wire when the input unit is in an ON configuration.

4. The removable handle according to claim 1, wherein the interface comprises a plug and socket type connection.

5. An input unit arranged to be detachably connectable to a controller of a power tool, the input unit comprising:
a user operable switch for controlling a power connection from a power supply to the motor; and
a no-volt prevention circuit configured to prevent a motor of the power tool from operating upon connecting the input unit to the controller when the user operable switch is in an ON configuration.

6. A power tool comprising:
a main body, the main body comprising a motor and a controller; and
a removable handle according to claim 1, the removable handle being removably attachable to the main body.

7. A power tool comprising:
a power supply;
a main body, the main body comprising a motor and a controller;
a removable handle according to claim 1, the removeable handle being removably attachable to the main body;
the input unit having an OFF configuration in which a supply of power from the power supply to the motor is OFF and an ON configuration in which the supply of power from the power supply to the motor is ON, the input unit being user actuatable between the OFF configuration and the ON configuration;
the wire assembly being for electrically connecting the input unit to the controller, and the interface being for coupling and decoupling the first wire to the controller; and
the no-volt prevention circuit being configured to prevent the motor from operating upon coupling the first wire to the controller when the input unit is in the ON configuration.

8. A power tool comprising:
a main body, the main body comprising a motor and a controller; and
an input unit arranged to be detachably connectable to the controller, the input unit comprising:
a user operable switch for controlling a power connection from a power supply to the controller; and
a no-volt prevention circuit configured to prevent the motor from operating upon connecting the input unit to the controller when the user operable switch is in an ON configuration.

9. The power tool according to claim 8, wherein the no-volt prevention circuit is configured to cause an ON signal to be sent to the controller on transition of the user operable switch from an OFF configuration to an ON configuration.

10. The power tool according to claim 8, wherein the no-volt prevention circuit is configured to cause an ON signal to be sent to the controller only when:
an input is received from a power supply before the input unit is placed in an ON configuration.

11. The power tool according to claim 8, wherein the no-volt prevention circuit is configured to cause a power signal to be output to a load switch in response to a transition of the user operable switch from an OFF configuration to an ON configuration.

12. The power tool according to claim 11, wherein the no-volt prevention circuit is configured to cause the load switch to operate.

13. The power tool according to claim 11, wherein the input unit comprises the load switch.

14. The power tool according to claim 11, wherein the load switch is configured to couple the power supply to an output of the load switch in response to receiving a power signal from the no-volt prevention circuit.

15. The power tool according to claim 8, wherein the input unit comprises a latch circuit configured to be connectable to the power supply.

16. The power tool according to claim 15, wherein the latch circuit is configured to be connectable between an input of the load switch and an output of the load switch.

17. The power tool according to claim 15, wherein the latch circuit is configured to output an OFF signal on connection of the input unit to the controller.

18. The power tool according to claim 16, wherein a latch circuit output of the latch circuit is connected to the input of the load switch, and a latch circuit input of the latch circuit is connected to the output of the load switch, and the latch circuit is configured to:
generate an ON signal at the latch circuit output in response to receiving an ON signal at the latch circuit input from the output of the load switch; and
latch the latch circuit output to the ON signal until the received ON signal is interrupted.

19. The power tool according to claim 16, wherein the latch circuit is configured to:
output an ON signal to the load switch input in response to:
receiving an ON signal from the load switch output; and
receiving an ON signal from the user operable switch.

20. The power tool according to claim 8, wherein the input unit comprises a user-operable switch for placing the input unit into the ON configuration or an OFF configuration.
